(19) United States
(12) Patent Application Publication
(10) Pub. No.: US 2010/0037968 A1
(43) Pub. Date: Feb. 18, 2010

(54) FLUID COUPLING, SYSTEM FOR VARYING THE DEADWEIGHT OF APPARATUS IN WHICH SUCH A COUPLING CAN BE INCORPORATED, AND A FLUID CONTROL VALVE INCORPORABLE IN SUCH A SYSTEM

(75) Inventor: Giovanni Bisutti, Cambridge Cambridgeshire (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: VM Technology Ltd, Cambridge Cambridgeshire (GB)

(21) Appl. No.: 12/530,856

(22) PCT Filed: Mar. 14, 2008
(86) PCT No.: PCT/GB08/50179

§ 371 Date: Oct. 7, 2009

(30) Foreign Application Priority Data
Mar. 16, 2007 (GB) 0705090.9

(51) Int. Cl. F16L 37/30

(52) U.S. Cl. 137/637.05

(57) ABSTRACT

A system for varying the deadweight of apparatus incorporates a fluid coupling (10) and fluid flow control valve. The fluid coupling comprises first and second connectors (20, 30) each configured for attachment (at respective ends 21 and 31) to respective fluid conduits (not shown), for example hydraulic hoses. Each connector (20,30) has a cylindrical body (3,3) configured to rotate about the longitudinal axis A having a bore or lumen (22,32) for fluid flow therethrough in a predetermined orientation as indicated by arrows D. Registration of the respective lumens (22,32) at ends (23,33) of the connectors permits fluid to flow between the connectors (20,30) at maximum rate when lumens (22,32) are aligned with apertures (24′,34)′ , fluid to be stopped when lumens butt against shutters (24,34), and fluid to flow at intermediate rate when lumens are registered in intermediate positions. In practice the fluid coupling provides a clear path with little resistance for the fluid to flow through resulting in low pressure drop and energy dissipation. The coupling also features the function of controlling the flow rate. The fluid flow control valve, compared to conventional valves, features large flow capacity and more reliable compression and lip seals rather than the less reliable O-ring sliding and diaphragm seals.

### TECHNICAL FIELD

The present invention relates to couplings for releasably joining together two fluid conduits, also a system for varying the deadweight of apparatus in which such a coupling can be incorporated.

### BACKGROUND ART

Couplings of the aforementioned kind may comprise two ball valves, each of which rotates about an axis perpendicular to the direction of flow. An alternative design employs two butterfly valves, the discs of which abut prior to rotation to allow fluid flow. Such rotation is again about an axis perpendicular to the direction of flow.

A particular form of coupling, known inter alia as a ‘dry break’ coupling, is designed such that it does not leak fluid when the conduits are separated. This is achieved by avoiding any volume between the two valves in which fluid can be retained after the valves have been closed and which would otherwise leak out when the two conduits are separated. However, such known constructions may present significant resistance to flow (with the associated energy consumption), may lack the ruggedness required for certain environments and/or may obstruct the passage of suspended solids if present in the fluid. They may additionally be cumbersome to connect/disconnect and be limited in their maximum working pressure.

One application for such couplings is in percussion power tool systems of the kind disclosed in WO99/10131, incorporated herein by reference. Such a system allows the deadweight of the power tool to be varied and comprises a chamber for mounting on the tool, a fluid reservoir supported independently of the tool, and means for cyclically filling the chamber with fluid from the reservoir in order to increase the deadweight of the apparatus and subsequently emptying the chamber by returning fluid to the reservoir in order to decrease the deadweight of the apparatus. The known system has three pneumatic connections—one to drive the tool hammer mechanism, another to pressurise the fluid chamber and a third to pressurise the fluid reservoir. This typically necessitates two pneumatic supply lines—the first to supply the pneumatic connections on the tool and the second to supply the connection on the reservoir. Non-variable mass pneumatic tools, in contrast, require only one pneumatic supply line.

Percussion power tool systems may also employ pilot-operated valves. FIG. 10 shows a conventional three-port, two-position poppet valve 200 actuated by a pilot actuator 210. Actuator 210 comprises a piston 220 moving in a cylinder 225 and connected to valve shaft 230 which moves along bore 240. Leakage between the actuator and valve is prevented by a sliding ‘O’ ring seal 245 between the bore 240 and shaft 230. However, such sliding seals are prone to wear. Bellows seals are not prone to wear but may not operate well in cold environments such as those experienced e.g. by percussion tool systems. An additional problem is presented by the valve shaft 230, which may present a significant obstacle to flow (indicated by arrow A) between ports 250,260 to either side of the shaft diameter.

It is one objective of the present invention to provide an improved coupling that at least ameliorates one or more of the above disadvantages.

It is another objective to provide an improved system having a reduced number of supply lines.

It is a further objective to provide a fluid powered actuator and valves which may incorporate such an actuator in which the above problems are mitigated.

### DISCLOSURE OF INVENTION

According to a first aspect the present invention, there is provided a coupling for releasably joining together two fluid conduits, comprising:

first and second connectors each for attachment to one fluid conduit and each having a body defining a lumen for fluid flow therethrough in a predetermined direction;

at least one connector further comprising a shutter movable in a plane perpendicular to the predetermined direction from a first position in which fluid flow through the lumen is prevented to a second position in which fluid flow through the lumen is allowed;

the first and second connectors being releasably interconnectable, with the lumens in their respective bodies being registerable when interconnected.

Unlike some conventional couplings, for example the butterfly valve construction described above, the apparatus of the present invention does not have any valve parts that can protrude from the lumen. Amongst other things, this can provide a more rugged construction.

Advantageously, both connectors comprise a shutter movable in a plane perpendicular to the predetermined direction from a first position in which fluid flow through the respective lumen is prevented to a second position in which fluid flow through the respective lumen is allowed.

The coupling may be configured such that the shutters of the two connectors abut when the first and second connectors are interconnected. Such abutment reduces any dead volume between the connectors that might otherwise harbour fluid that would leak out when the connectors were disconnected.

The shutters may have respective apertures for fluid flow therethrough, in which case at least one connector may comprise a plug to block the respective aperture when the shutter is in said first position. There may be provided an externally-actuable member for moving said plug in and out of engagement with its respective aperture. Alternatively, the plug of one connector may be biased into engagement with its respective aperture and be configured to move out of engagement when subject to the pressure of fluid in the lumen of the other connector. A plug may be configured to block the aperture of both connectors.

Advantageously, the shutter is configured to rotate about an axis substantially parallel to said predetermined direction. A connector may comprise a sleeve configured to rotate relative to the respective body defining a lumen. In this case, the plug may have a surface configured to engage the sleeve and move in and out of engagement with the respective aperture with rotation of the sleeve. Both connectors may comprise plugs, the plugs being configured to abut when the respective shutters are in their first positions.

The sleeve may rotate about the axis of the body and may have a bore in which the body rotates.

The shutter may be immovably fixed to the sleeve and may actually be integral with the sleeve. The lumen in the body may taper along its length, becoming narrower as it approaches the shutter. Adjacent the shutter, the axis of the lumen may be offset from the axis of the body.

The sleeve of the first connector may have a further bore configured to receive the second connector. The sleeve may also have an interconnector for releasably attaching the first connector to the second connector. The interconnector may be one half of a bayonet fixture.

According to a second aspect the present invention, there is provided a system for varying the deadweight of apparatus, the system comprising

a chamber for mounting on the apparatus and communicating via a conduit with a fluid reservoir supported independently of the apparatus,

a valve arrangement configured to cyclically fill the chamber with fluid from the reservoir in order to increase the deadweight of the apparatus and subsequently empty the chamber by returning fluid to the reservoir in order to decrease the deadweight of the apparatus,

the valve arrangement and chamber being further configured to introduce gas under pressure into the chamber such that it flows through the conduit and into the reservoir, thereby pressurizing the fluid in the reservoir,

the valve arrangement being further configured to reduce the pressure of the gas in the chamber such that the pressurized fluid in the reservoir flows through the conduit and into the chamber.

By using gas from the chamber to pressurise the reservoir, it is possible to dispense with the separate reservoir supply line of the prior art, thereby reducing the number of pneumatic supply lines overall. Amongst other things, fewer pipelines make the equipment easier to use and thus more attractive to customers.

The valve arrangement may be configured to release gas from the chamber but to prevent fluid from escaping the chamber and, to this end, may comprise a float valve configured to close when the fluid in the chamber reaches a predetermined level. The fluid reservoir may also comprise an exhaust port set to bleed air to atmosphere at a controlled rate in series with a valve set to shut when pressure in reservoir falls below a certain level.

The conduit may communicate with the reservoir at a point below the lowest level of fluid in the reservoir when in operation. This helps ensure that fluid, not gas, is returned to the chamber from the reservoir. The conduit may be attached to the lowermost point of the reservoir when in operation.

Where the apparatus is actuated by pressurized gas, particularly where the apparatus is a percussion power tool, the system may further comprise a valve arrangement for coupling to a pressurized gas supply and which controls both fluid displacement in the chamber and the actuation of the apparatus.

The second aspect of the invention also provides a method of operating a system for varying the deadweight of apparatus,

the system comprising a chamber for mounting on the apparatus and communicating via a passageway with a fluid reservoir supported independently of the apparatus, and a valve arrangement configured to cyclically fill the chamber with fluid from the reservoir in order to increase the deadweight of the apparatus and subsequently empty the chamber by returning fluid to the reservoir in order to decrease the deadweight of the apparatus,

the method comprising the steps of

introducing gas under pressure into the chamber such that it flows through the passageway and into the reservoir, thereby pressurizing the fluid in the reservoir;

reducing the pressure of the gas in the chamber such that the pressurized fluid in the reservoir flows through the passageway and into the chamber, thereby increasing the deadweight of the apparatus.

The second aspect of the invention also provides a percussion power tool comprising:

a body housing a member with a reciprocating percussive action;

a chamber coupled to the body;

a fluid inlet for introducing fluid into the chamber; and

a valve arrangement configured to displace fluid out of the chamber using pressurized gas,

fluid being stored in the chamber to increase the deadweight of the percussion tool when the member is reciprocating or percussing, and subsequently emptied when it is idle, wherein

the chamber is configured to allow direct contact between the pressurized gas and the fluid.

By allowing the gas direct contact with the fluid, it is possible for gas to make its way back along the fluid supply pipeline and into the reservoir where it pressurizes the fluid. This is in contrast to conventional technology where gas and fluid are as far as possible kept separate in order to keep the gas dry.

The percussion power tool may further comprise a valve arrangement configured to reduce the pressure of the gas in the chamber. The valve arrangement may be configured to release gas from the chamber. The valve arrangement may be configured to prevent fluid from escaping the chamber and, to this end, may be a float valve configured to close when the fluid in the chamber reaches a predetermined level.

The tool may further comprise a valve arrangement for coupling to a compressed gas supply and which controls both fluid displacement for filling and emptying the chamber and the reciprocating percussive action of the member.

According to a third aspect the present invention, there is provided a fluid flow control valve comprising

a first fluid passageway and a valve member movable to control fluid flow therethrough

the valve member being kinematically connected to a fluid powered actuator, the actuator comprising

a piston subjectable to fluid pressure in a chamber and movable along a first axis,

the piston having a first sealing surface engageable with a second sealing surface of the chamber to restrict fluid leakage out of said chamber,

wherein said first and second sealing surfaces each lie substantially in a plane extending substantially normal to said first axis.

First and second sealing surfaces which each lie substantially in a plane extending substantially normal to said axis define a more reliable compression seal rather than the less reliable O-ring sliding seal disclosed in the prior art of FIG. 10.

The piston may comprise a lip seal providing said first sealing surface. The chamber may have a wall lying in a plane substantially normal to said axis and providing said second sealing surface. The actuator may be configured to have a gap between said piston and the wall of said chamber to allow debris and/or condensation to pass.

The third aspect of the invention also provides a fluid flow control valve comprising

a first fluid passageway and a valve member movable to control fluid flow therethrough,

wherein the valve member is kinematically connected to a fluid powered actuator as set out above.

The valve member may be movable along a second axis coaxial with the first axis of movement of the piston of the fluid powered actuator.

The valve member may comprise a third sealing surface engageable with a fourth sealing surface of said first fluid passageway to restrict fluid flow therethrough. The third and fourth sealing surfaces may each lie in a plane extending substantially normal to said second axis. The valve may be configured such that the pressure acting across said piston when said first and second sealing surfaces are engaged acts substantially in opposition to the pressure acting across said valve member when said third and fourth sealing surfaces are engaged.

The valve may further comprise a second fluid passageway, the valve member further comprising a fifth sealing surface engageable with a sixth sealing surface of said second fluid passageway to restrict fluid flow therethrough. The first and second fluid passageways may be connected to a manifold chamber having a third fluid passageway.

The piston and said valve member may be connected by a shaft passing through said manifold chamber. The shaft also passes through said second fluid passageway and may be slideably located in a bore connecting said chamber with said manifold chamber. The shaft has may have an aperture to facilitate fluid flow through said second fluid passageway, the aperture being a bore passing diametrically through said shaft and which may also be angled relative to the shaft axis so as to provide a substantially direct flow path in said manifold chamber between said second and third fluid passageways.

The third aspect of the invention also provides a fluid flow control valve comprising a first fluid passageway having an associated first sealing surface;

a valve member having an associated second sealing surface and movable by an actuation member along a first axis to bring said first and second sealing surfaces into engagement and thereby control fluid flow through said passageway;

wherein said actuation shaft passes through said passageway and has an aperture to facilitate fluid flow through said passageway.

The first and second sealing surfaces may be substantially perpendicular to said first axis. The actuation member may have a longitudinal axis substantially parallel to that of the first fluid passageway.

At an opposite end of said passageway to said first sealing surface, the passageway may join a further passageway having a longitudinal axis oriented at a non-zero angle to that of the first fluid passageway. The longitudinal axis of the further passageway may be substantially perpendicular to that of the first fluid passageway.

The aperture may be a bore passing diametrically through said actuation member, and may be oriented at a non-zero angle relative to the longitudinal axis of the actuation member such as to provide a substantially direct flow path through said actuation member and into said further passageway.

### BRIEF DESCRIPTION OF DRAWINGS

Embodiments of the invention will now be described by way of example with reference to the accompanying drawings, in which:

FIG. 1 is a longitudinal cross-sectional view of an embodiment of the invention in an open state in which fluid flow is permitted;

FIG. 2 corresponds to the view of FIG. 1 when in a closed state in which fluid flow is prevented;

FIG. 3 is an exploded perspective view of the embodiment of FIGS. 1 and 2;

FIGS. 4A and 4B are longitudinal cross-sectional views of a second embodiment of the first aspect of the invention in closed and open positions;

FIGS. 5 and 6 are longitudinal cross-sectional views of a third embodiment of the first aspect of the invention in closed and open positions;

FIG. 7 is a longitudinal cross-sectional view of a fourth embodiment of the first aspect of the invention;

FIG. 8 illustrates further detail of a coupling according to the first aspect;

FIG. 9 is a diagrammatic view of the system according to a second aspect of the invention;

FIG. 10 is a diagrammatic view of prior art relevant to a third aspect of the invention;

FIGS. 11 and 12 are diagrammatic views of an embodiment of the third aspect of the invention in first and second positions.

### DETAILED DESCRIPTION OF SPECIFIC EMBODIMENTS

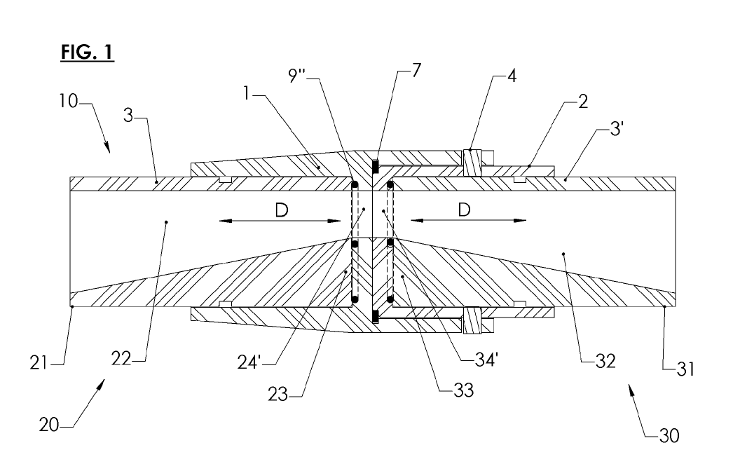

FIG. 1 is a longitudinal sectional view of the coupling 10 of the present invention. The coupling comprises first and second connectors 20, 30 each configured for attachment (at respective ends 21 and 31) to respective fluid conduits (not shown), for example hydraulic hoses.

Each connector 20,30 has a cylindrical body 3,3′ having a bore or lumen 22,32 for fluid flow therethrough in a predetermined orientation as indicated by arrows D. Registration of the respective lumens 22,32 at ends 23,33 of the connectors remote from the connections to the fluid conduits at 21 and 31 permits fluid to flow between the connectors 20,30. Swivel joints (not shown) may be provided in order that lumens and fluid conduits may move independently of one another.

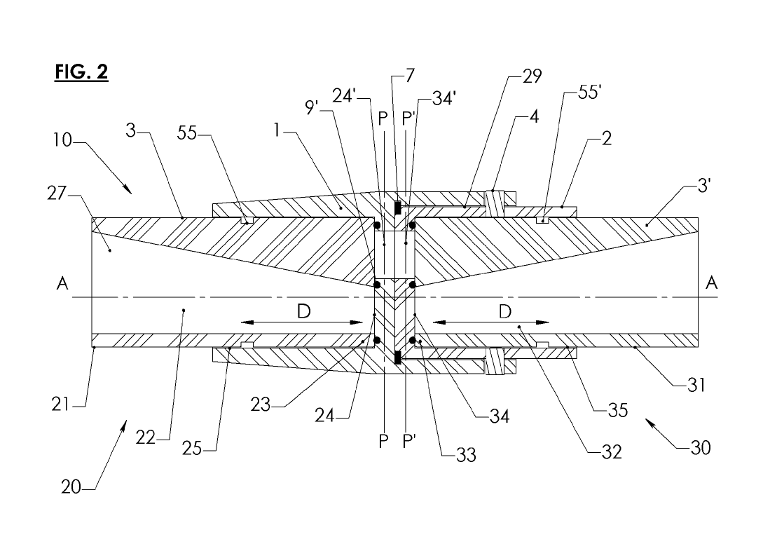

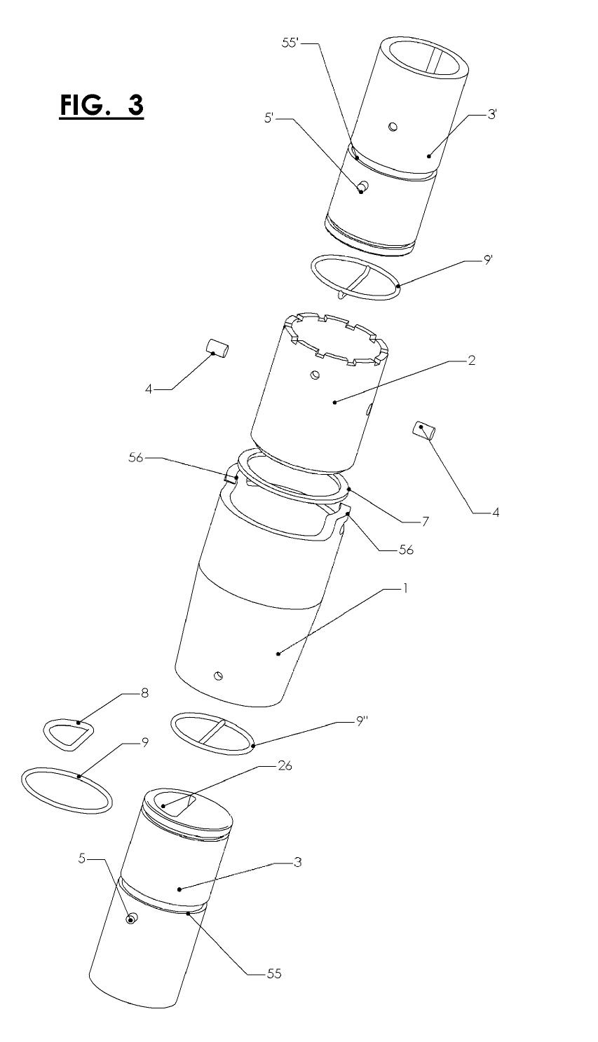

FIG. 2 shows the coupling 10 of the present invention when arranged to prevent fluid flow through the lumens 22,32 and hence between the connectors 20,30. Each lumen 22,32 is sealed at the end 23,33 by a respective shutter 24,34 provided with a seal member between the surface of the shutter and the end face of the body as shown at 8 in FIG. 3. The purpose of the seal member 8, sitting either in a groove on the face of cylindrical bodies 3,3′ at the ends 23,33 or in a groove on the shutters 24,34 of bodies 1 and 2, is to prevent fluid loss between lumen and shutter in the closed position when the connector is not coupled to the other connector. An ‘O’ ring 9 sitting e.g. in a circumferential groove on the body 3, ensures a fluid-tight seal between sleeves 3,3′ and bodies 1,2. Alternative configurations of this sealing arrangement are shown at 9′ and 9″ in FIG. 3 where the function of seals 8 and 9 are unified into a single item with seal 9″ limiting the wetted area to shutters 24,34.

Referring to shutter 24, this is immovably fixed to and integral with a sleeve 1 having a bore 25 in which body 3 is mounted for relative rotation. A grab pin 5 in the sleeve engages a circumferential groove 55 in the body to keep sleeve and body in axial engagement without preventing relative rotation.

By rotating the sleeve 1 relative to the body 3 about the bore axis AA (which is also substantially parallel to the predetermined direction of fluid flow, D), shutter 24 can be moved relative to the respective lumen 22 from a first position of FIG. 2, in which fluid flow through the lumen 22 and the other connector 30 is prevented, to the second position of FIG. 1 in which fluid flow through the lumen and the other connector is allowed. Referring to FIG. 2, it will be evident that shutter 24 moves in a plane P which is substantially perpendicular to the predetermined orientation of fluid flow through the lumens of the connectors as indicated by arrows D. Shutter 34 similarly moves in a plane P′ which is substantially perpendicular to the predetermined orientation of fluid flow D.

In the construction shown, the cross-sectional area of the lumen 22 at end 23 of the connector 20 is smaller than that at the end 21 of the connector for connection to the fluid conduits or hoses. As shown in FIG. 3, the end/aperture 26 of the lumen has a semicircular cross-section 26 offset from the axis of the body 3 and is sealed by a correspondingly D-shaped sealing ring or gasket 8. The cross-sectional area of lumen 22 at end 23 needs to be smaller than the area of shutter 24 to enable full overlap by the shutter itself. This means that the largest possible cross-sectional area of lumen 22 at end 33 needs to be less than half of the total available area at end 23, hence the semi-circular cross-section offset from the axis. Were this not the case, in the close position, the shutter would not fully overlap aperture 26 therefore not sealing properly. To reduce pressure losses, lumen 22 has a gradual taper from its end 27 adjacent the fluid conduit connection to the aperture 26.

Connector 30 has a similar construction with a shutter 34 forming part of a sleeve 2 having a bore 35 allowing relative rotation to the body 3′. Fluid sealing is provided by seal 9′ which seals both the gaps between the shutter and the end face of the body and between body 3′ and sleeve 2. A grab pin 5′ and respective groove 55′ ensures that the body cannot be ejected from the sleeve. Both grooves 55 and 55′ can be semicircular so as to provide end stop positions for body 3,3′ relative to sleeve 1,2. The grooves 55,55′ may further be oriented such that when bodies 3,3′ are rotated relative to their respective sleeves 1,2 to the fully open position, the twisting of the two fluid conduits attached to the connectors cancel each other out.

Connector 30 is however configured as a male connector component, insertable within a further bore 29 of the first, female connector 20 which is configured to receive the male connector. Located axially on the opposite side of the shutter 24 to bore 25, further bore also contains a flat gasket 7 to create a fluid seal between the first and second connectors.

The sleeve 1 of connector 20 is also provided with bayonet prongs (indicated at 56 in FIG. 3) which, on relative rotation of the two connectors, engage with pins 4 on the sleeve 2 of connector 30 to interconnect the two connectors together in a releasable fashion as is known per se.

The parts 56,4 of the interconnector are positioned on the circumference of the sleeves 1,2 such that the shutters 24, 34 (and indeed the corresponding apertures 24′,34′ in the faces of the sleeves 1 and 2—see FIG. 1—that allow fluid flow between the two connectors) are aligned. Relative rotation of the interconnected sleeves 1,2 relative to the connector bodies 3,3′ (and the fluid hoses to which these may be attached), will rotate the respective shutters relative to the lumens and increase/decrease the obstacle to flow accordingly.

Not only do the shutters align following interconnection, they also abut so as to reduce the dead volume between the connectors that might otherwise harbour fluid that would leak out when the connectors are disconnected.

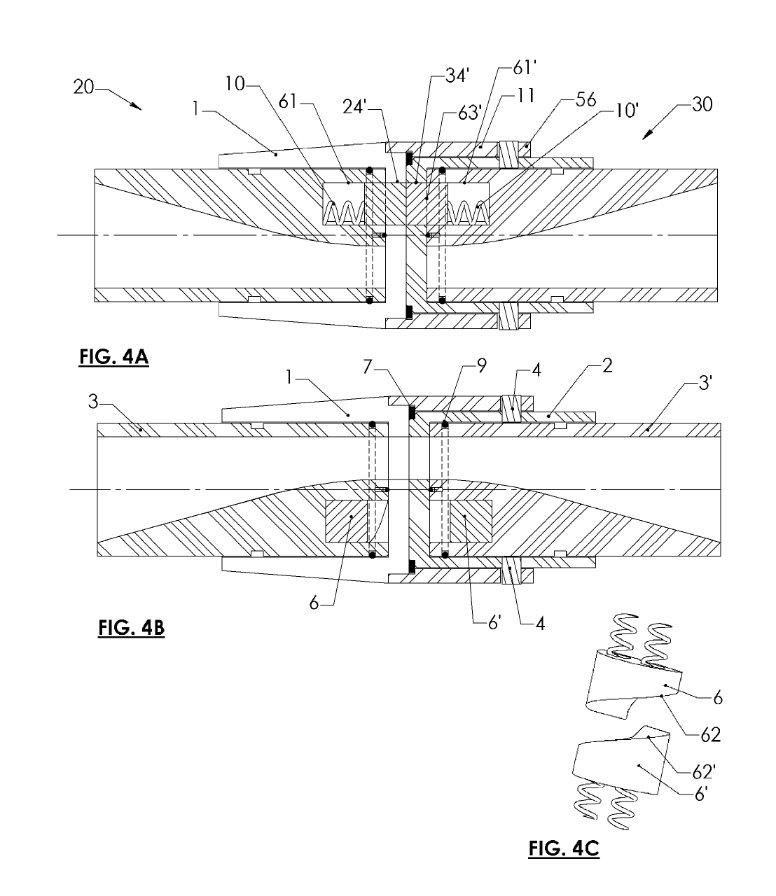

A small amount of fluid may still be retained in the apertures 24′,34′. This amount is reduced in the embodiment of FIGS. 4A and 4B, where each connector 20,30 is provided with plugs 6, 6′ sliding in bores 61, 61′ in the respective body 3,3′ and biased by springs 10, 10′. As illustrated in FIG. 4A, plugs 6,6′ slide into apertures 24′,34′ when the latter are not aligned for fluid flow, thereby filling the dead volume that would otherwise harbour fluid.

As shown in FIG. 4C, plugs 6, 6′ are of semi-circular cross-section and have an end face having a partially helical (spiral) periphery 62, 62′. These faces are configured such that when the two plugs abut as shown in FIG. 4A, no dead volume is left between them. The spiral periphery also engages with the inside edge of the respective aperture (i.e. plug 6 engages with aperture inside edge 63 and plug 6′ engages with edge 63′) such that when the respective body 3 and 3′ rotates relative to the respective sleeve 1 and 2, plugs 6, 6′ move along bore 61, 61′ against the bias of their springs 10, 10′.

The embodiment of FIGS. 4A-C also utilises a bayonet locking mechanism in which the at least one prong 56 (for engaging with a pin 4 on sleeve 2 of connector 30) is mounted on a further sleeve 11 which is rotatable relative to the main sleeve 1 of connector 1). This allows the two connectors to be joined without rotation of sleeves 1,2 (which rotation will be prevented by engagement of the plugs 6,6′).

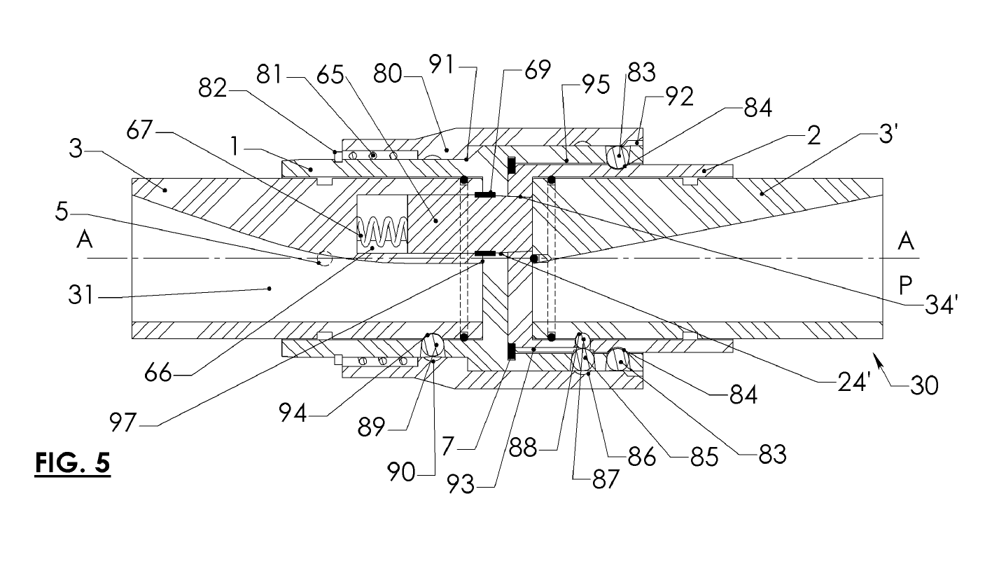

FIG. 5 illustrates a different embodiment of a connector which, like the connector of FIG. 4, seeks to reduce dead volume that might otherwise give rise to leakage when the connectors are separated. A single plug 65 is biased by spring 67 so as to extend through the aperture 24′ of connector 20 and into the aperture 34′ of connector 30 where its end face abuts the body 3′. In this way, the dead volume of the apertures is filled.

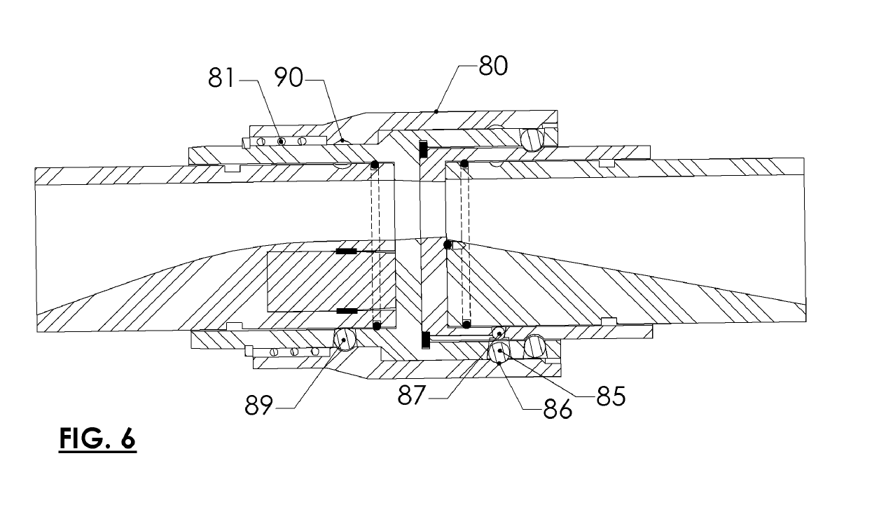

However, when body 3′ is rotated so that lumen 32 is aligned with the end face of the plug, the fluid pressure pushes the plug out of both apertures 24′, 34′, allowing the body 3 of connector 1 to be rotated such that its lumen 22 aligns with lumen 32, thereby allowing fluid flow. This is illustrated in FIG. 6.

Seal 69 between the aperture 24′ and plug 65 prevents any fluid escaping when the connector is disconnected with plug 65 fully exposed. It also prevents fluid ingress into chamber 66 behind the plug 65.

Connector 20 features a locking ring 80 freely rotating around axis AA and sliding along axis AA relatively to sleeve 1 between pin 5 and change of diameter 91 on sleeve 1. Locking ring 80 is normally kept against end stop 91 by spring 81 which compresses against clip 82. In this position ring 80 keeps locking balls 83, which are constrained within truncated conical housings in sleeve 1 to move radially, protruding beyond the internal cylindrical face 95 of sleeve 1. Ball 85, ball 87 and ball 89 are safety features preventing the accidental releasing of connectors 20 and 30 when the flow is on.

When connectors 20 and 30 are brought together the front face of sleeve 2 hits locking balls 83. To let connector 20 entering sleeve 1, locking ring 80 needs to slide to the left against end stop 5 so that circumferential groove 92 is presented to the balls enabling them to move away from sleeve 2 and not to protrude anymore beyond the internal cylindrical face 95 of sleeve 1.

When the outside cylindrical surface of sleeve 2 has gone beyond the plane of locking balls 83, locking balls 83 enter the space within groove 92 and by doing sow prevents locking ring 80 to move to its rest position. In this position, circumferential groove 86 is no longer facing ball 85 which is then made to protrude beyond the internal cylindrical face 95 of sleeve 1. To let sleeve 2 and therefore connector 20 further entering sleeve 1, groove 93 parallel to axis AA is provided on outside cylindrical surface of sleeve 2.

To let connector 20 further entering sleeve 1, plug 65 needs to engage with aperture 34′. When sleeve 2 butts against gasket 7 of sleeve 1, circumferential groove 84 on outside cylindrical surface of sleeve 2 is presented to locking balls 83 thus letting spring 81 to push locking ring 80 to its rest position. This in turn pushes locking balls 83 against groove 84 therefore securing connector 20 and 30 together.

When connectors 20 and 30 are engaged, as soon as body 3′ is turned relatively to sleeve 2 around axis AA, hemispherical groove 88 on outside face of body 3′ moves away from ball 87 constrained to move radially within a truncated conical housing in sleeve 2. Ball 87 is now pushed against ball 85 which in turn is pushed against circumferential groove 86 therefore preventing locking ring 80 from being slid and the connectors from being released.

Similarly, as soon as body 3 is turned relatively to sleeve 1 around axis AA, hemispherical groove 94 on outside face of body 3 moves away from ball 89 constrained to move radially within a truncated conical housing in sleeve 2. Ball 89 is now pushed against circumferential groove 90 therefore preventing locking ring 80 from being slid and the connectors from being released.

To disconnect connectors 20 and 30, first body 3′ needs to be turned around AA to fully shut aperture 34′. Then body 3 can be turned around AA fully to present plug 65 to aperture 24′. Spring 67, which is in a loaded state can now extend to its original length and push plug 65 out fully to displace any fluid trapped within aperture 24′ and 34′ into lumen 31 though a small gap 97 between body 3 and sleeve 1. To facilitate the displacement of the fluid trapped within the above said apertures the end of plug 65 and apertures 24′ and 34′ feature matching drafts so that contact surface to surface takes place in this area only when plug 65 is fully extended.

When body 3 fully shuts aperture 24′ and body 3′ fully shuts aperture 34′, hemispherical grooves 94 and 88 are presented to balls 89 and 87 thus letting ball 89 and ball 85 to move away from circumferential grooves 90 and 87 respectively and thus enabling locking ring 80 to be slid again.

To release connector 20 from 30, locking ring 80 needs to be slid towards end stop 5 therefore presenting groove 92 to balls 83 and letting them move away from groove 84.

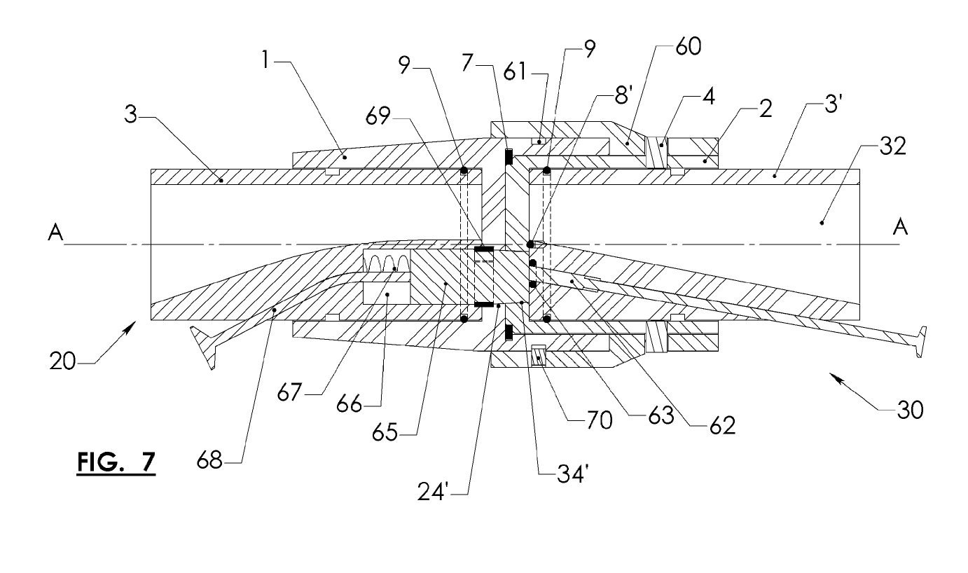

FIG. 7 shows a further embodiment of the connector of FIGS. 5 and 6 in which plug 65 is moved against spring 67 not by fluid pressure but instead by a push rod 62 acting on the front face of the plug 65 or by a pull rod 68 attached to the rear of the plug 65. Push rod 62 moves in a bore in the body 3′ of connector 30 and may be sealed by an O-ring 63. Flexible pull rod moves in a bore in the body 3 of connector 2.

As with the previous embodiment, retraction of plug 65 into chamber 66 allows both bodies 3,3′ to be rotated relative to the sleeves 1,2, thereby aligning apertures 24′,34′ and lumens 22,32.

To disconnect connectors 20 and 30, first body 3 needs to be turned around AA to present plug 65 to aperture 24′. Spring 67, which is in a loaded state can now extend to its original length and push plug 65 out fully to displace any fluid trapped within aperture 24′ and 34′ into lumen 32. Body 3′ can then be turned so that lumen 32 is presented against the shutter. Locking ring 60 can now be turned to release pin 40 thus allowing disconnection.

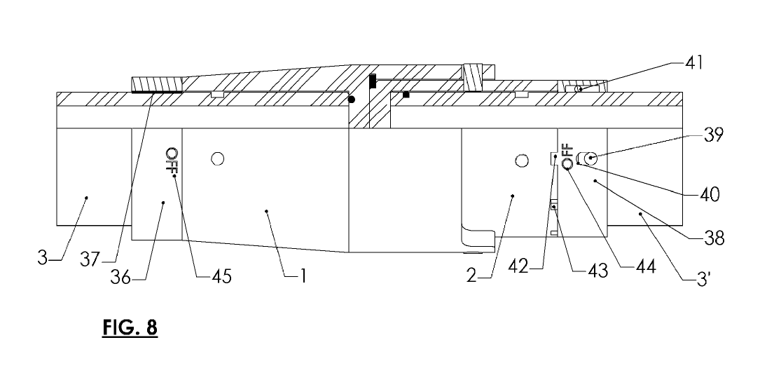

Referring to FIG. 8, this shows two possible solutions to make sure hose twisting does not cause unwanted opening or closing of coupling.

The first example employs a ring 36 concentric to body 3 and allows infinite locking positions between body 3 and sleeve 1. Ring 36 interfaces with body 3 through thread interface 37 which can be left handed or right handed. Ring 36 is therefore axially constraint to body 3 but can turn relatively to body 3. Depending on the orientation of the thread, ring 36 can be pressed against sleeve 1 by appropriately turning ring 36 relatively to body 3, therefore locking body 3 in any position relatively to sleeve 1.

The second example employs ring 38 concentric to body 3′ and allows only discrete locking positions between body 3′ and sleeve 2. Ring 38 is provided with a slot 40 acting as a guide and providing end stop positions for a pin 39 which is inserted in body 3′. Ring 38 is therefore rotationally constraint to body 3′ but can slide relatively to body 3′ in the direction of flow between two end positions. Ring 38 features a tooth 42 which may engage with any of a series of slots 43 on sleeve 2.

Spring 41 acting between ring 38 and pin 39 pushes ring 38 towards sleeve 2. By sliding ring 38 away from sleeve 2, tooth 42 disengages from sleeve 2 allowing body 3′ to turn relatively to sleeve 2 until another position is reached where tooth 42 can engaged with another slot of the series of slots 43. Labelling 44 relatively to sleeve 2 or labelling 45 relatively to sleeve 1 indicates whether flow from one side of the coupling is prevented (OFF position shown), or flow is at its maximum in the fully open position (MAX position not shown) or at any intermediate flow rate.

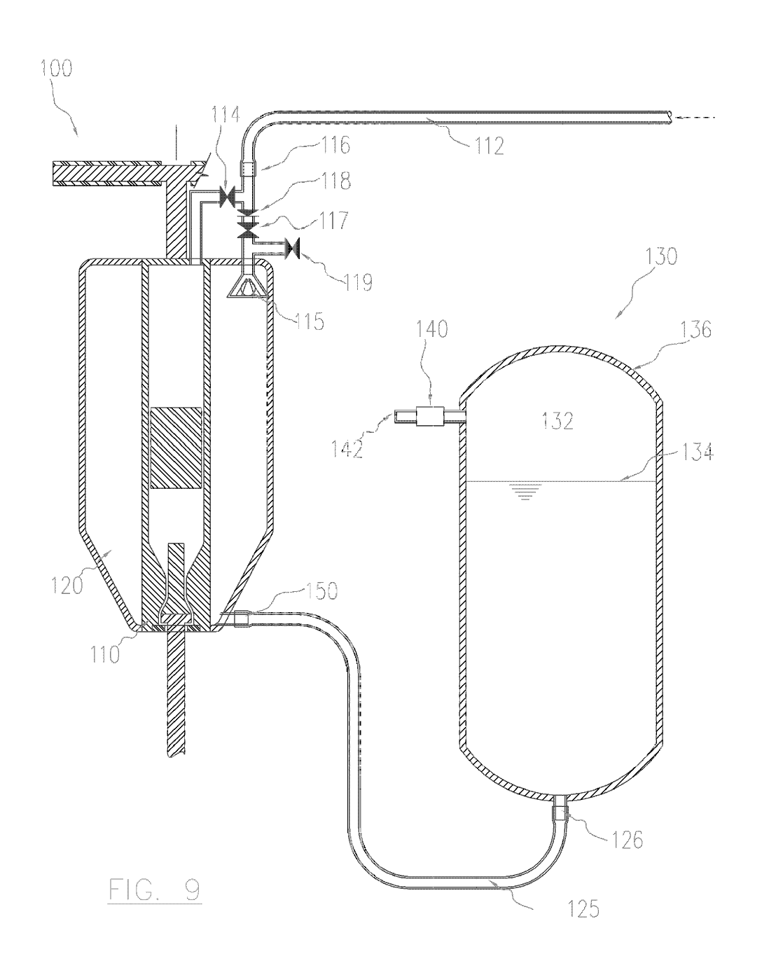

Referring now to FIG. 9, there is shown a system 100 for varying the deadweight of an apparatus, in this case a pneumatic hammer 110 connected to a pneumatic supply line 112 via a coupling 116, examples of which are illustrated under the first aspect of the present invention, and control valve 114.

A chamber 120 mounted on the hammer 110 is connected via a fluid conduit or hose 125 to a reservoir 130 supported independently of the hammer, e.g. on a trolley. As known from the aforementioned WO99/10131, fluid can be transferred from the reservoir 130 to the chamber so as to increase the mass of the hammer assembly and reduce loads on the hammer operator. Once hammer operation is complete, chamber 120 can be pressurised with gas so as to drive the fluid back into the reservoir. The hammer assembly is then much lighter and consequently easier for the hammer operator to move.

FIG. 9 shows the system with the hammer in its pre-operation, unloaded state. When the air compressor (not shown) is started and compressed air flows along line 112, compressed air fills up the chamber or breaker vessel 120 via non-return valve 118, displacing any fluid in the chamber fluid, typically water, through hose 125.

Chamber 120 is configured without a membrane or bellows between the fluid and the gas, allowing direct contact between the pressurised gas and the fluid. Accordingly, when the water level goes below that of the chamber inlet coupling 150, examples of which are illustrated under the first aspect of the present invention, gas enters the hose and travels into the reservoir 130 via reservoir inlet coupling 126 where it bubbles up into the space 132 between the surface of the fluid 134 and the top of the reservoir container 136.

The gas pressure at the top of the reservoir is set, typically slightly lower than pressure in chamber 120 as a suitably sized orifice 142 bleeds some gas at a much lower rate than the pressurizing flow rate passed by hose 125. The system is now ready to operate.

To operate the hammer, the operator opens valve 114 as mentioned above. At the same time, a mechanical or air line link shuts the normally-open port 117 between the air line and the chamber and opens the normally-closed port 119 between the chamber and the atmosphere, allowing air to exhaust from the chamber to atmosphere; the functions of port 117 and 119 being integrated as an example into a single block as illustrated under the third aspect of the present invention. The resulting reduction of gas pressure in the chamber allows fluid from the reservoir 130 into the chamber 120. Thus a single valve operation controls both fluid displacement in the chamber and the actuation of the hammer.

The positioning of the reservoir fluid inlet 126 below the lowest level of fluid in the reservoir when in operation ensures that fluid, not gas, is returned to the chamber from the reservoir. In the embodiment shown, the reservoir fluid inlet is positioned at the very bottom of the domed end of the reservoir.

The maximum fluid level in the chamber is limited by float valve 115, which allows gas to escape the chamber but which prevents fluid from escaping the chamber. Once the maximum fluid level is reached, fluid transfer from the reservoir to the chamber stops. Orifice 142 keeps bleeding gas from the reservoir until a pressure of 1 bar gauge is reached; at this stage valve 140 is set to close and prevent any further bleeding. To the extent that the pressure within the reservoir is above the 1 bar gauge threshold of valve 140, the valve continues to operate until the threshold is met. 1 bar has been found to be high enough to keep fluid in the chamber yet low enough to offer low resistance to the return of fluid to the reservoir itself therefore reducing the transfer time of the fluid from the chamber to the reservoir.

The operator stops operation of the hammer by closing valve 114. By means of the link described above, atmosphere port 119 is closed and air line port 117 is opened, allowing compressed air into the chamber which drives fluid back to the reservoir as described above.

It will be appreciated that the arrangement of valves 114, 115, 117-119 and the connector 116 may be separate elements or may be integrated into a single block.

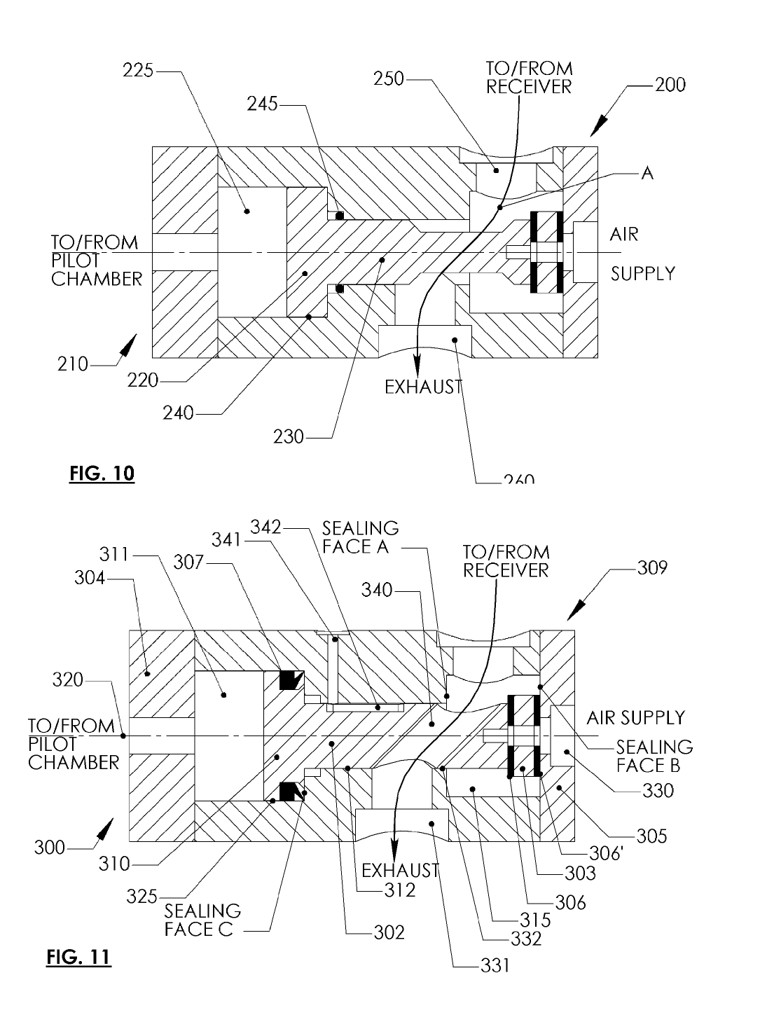

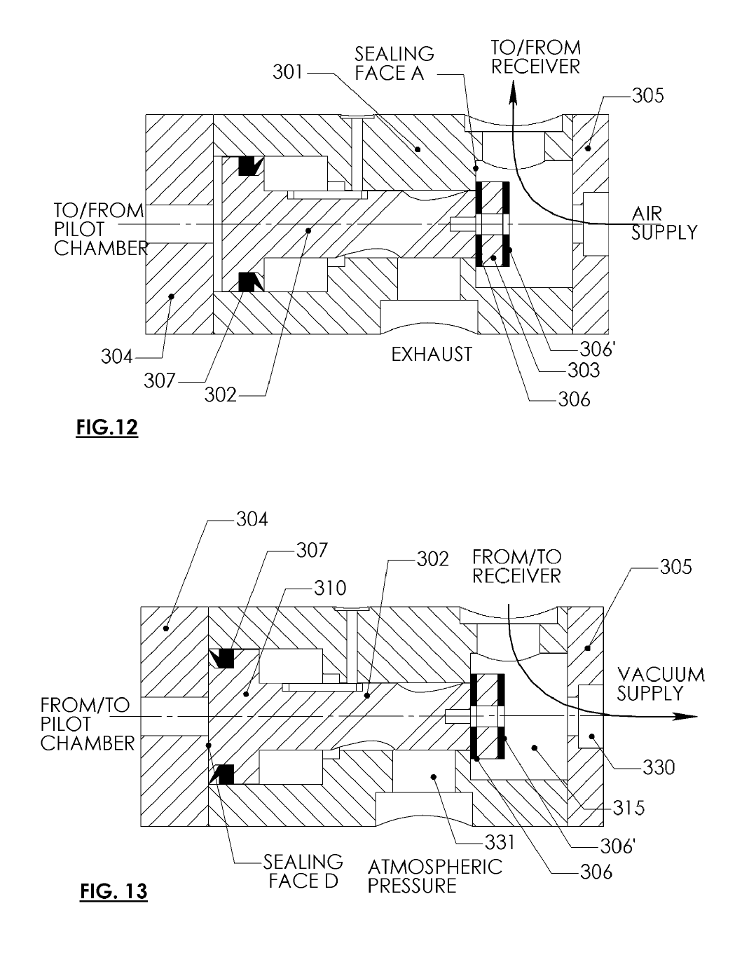

FIGS. 11, 12 and 13 are sectional views of a three-port, two-position poppet valve 309 incorporating the third aspect of the invention. FIG. 11 shows the valve in a first position for a pressure application in which flow (indicated by arrow) is between receiver and exhaust ports. FIG. 12 shows the valve for the same pressure application in a second position in which flow (indicated by arrows) is between supply ports and receiver. FIG. 13 shows the valve configured to operate in a vacuum application in which flow (indicated by arrow) is between receiver and vacuum supply ports. As in the prior art example of FIG. 10, the valve is kinematically connected via a shaft 302 to a pilot actuator 300 for movement along an axis 320.

Actuator 300 comprises a piston 310 moving in a cylinder or pilot chamber 311, which itself is formed in one end of a body 301 and closed by an end cap 304.

Valve assembly comprises spacer 303 and axially-spaced seals 306,306′ moving in a manifold chamber 315 formed at the other end of the body 301 and closed by a cap member 305. Chamber 315 communicates with receiver, exhaust and supply ports, the exhaust and supply ports having respective sealing faces A and B. Depending on whether the piston 310 is in the leftmost position in pilot chamber 311 (FIG. 12) or in the rightmost position (FIG. 11), seals 306 and 306′ respectively engage either face A or face B, fluid flow being permitted between those ports of the manifold chamber 315 that are not sealed.

According to the third aspect of the invention, sealing between the pilot chamber 311 and manifold chamber 315 is achieved by a lip seal 307 that engages with the chamber end face C extending substantially normal to the chamber axis 320 along which piston movement takes place. In contrast to ‘O’ ring seal of the prior art arrangement of FIG. 10, the sealing surfaces of the lip seal 307 and of the chamber are planar and are pressed together by the very pressure acting on the seal. Moreover, unlike a continually sliding ‘O’ ring, the sealing surfaces only engage at the end of the actuator stroke. Indeed, the bore of the chamber 311 and the outside diameter of the piston 310 can be sized to provide a gap (indicated at 325) through which debris and/or condensate might pass instead of inhibiting valve movement.

Considering now the construction of the valve itself, this utilises a third sealing surface 306′ engageable as shown in FIG. 11 with a fourth sealing surface, face B, of a fluid passageway (‘air supply’ 330) to restrict fluid flow therethrough. As a result of both seal 306′ and surface B lying in a plane extending substantially normal to axis 320, a more reliable compression seal is provided.

The valve and actuator—particularly the dimension of shaft 302—are configured such that the engagement of the valve seal 306′ is substantially synchronised with the engagement of the actuator lip seal 307 with face C, the flexible lip providing that extra adjustment required to achieve perfect sealing action on both sealing faces B and C as it is notoriously difficult if not impossible to provide multiple face to face sealing action along a single shaft by using only surface gasket seal of the type indicated at 306.

Where the port sealed by the valve is at higher pressure than the manifold, thus generating a force tending to keep the valve open (as in the ‘air supply’ port 330 of FIG. 11), the actuator is configured to oppose that force, particularly when actuator seal 307 and sealing surface C are engaged.

When the supply pressure to the actuator is released, the higher air supply pressure acting at 330 will typically push the spool to the left as shown in FIG. 12.

In this position, a fifth sealing surface 306 engages with a sixth sealing surface, face A, of said second fluid passageway (‘exhaust’ 331) to restrict fluid flow therethrough.

As in the prior art arrangement of FIG. 10, the shaft 302 connecting the piston and valve assembly passes through a bore 312 connecting the pilot and manifold chambers and also through the aperture 332 defining part of the second passageway connecting manifold chamber with the exhaust port.

To reduce resistance to fluid flow through this second passageway, shaft 302 is provided with a diametrical bore 340 which is advantageously angled so as to provide a substantially direct flow path between the ports, as indicated by the arrows in FIG. 11. To prevent turning of shaft 32 and port 340 relatively to body 301 a hole 341 in body 301 is provided for a locating pin to engage with groove 342 on shaft 302. It will be appreciated that this latter feature can be implemented independently of the third, actuator seal, aspect of the invention discussed above.

The construction of the valve for vacuum applications shown in FIG. 13 differs from the valve construction for pressure applications shown in FIGS. 11 and 12 only in the placement of lip seal 307 which is now fitted to the other face of piston 310 with the lip positioned to provide seal against sealing face D rather than sealing face C.

The operation in vacuum application of the valve shown in FIG. 13 requires the application of vacuum to port 330 rather than air supply and also the application of vacuum to pilot chamber 311 rather than air supply when the position of the piston needs shifting from the rightmost position (sealing surface 306′ engaged with sealing surface B) to the leftmost position (sealing surface 306 engaged with sealing surface A).

Where the manifold 315 is at lower pressure than the atmospheric pressure at port 331 as result of vacuum applied at port 330, thus generating a force tending to detach sealing surface 306 from sealing surface A, the actuator is configured to oppose that force, particularly when actuator seal 307 and sealing surface D are engaged as shown in FIG. 13. In this position flow is from the receiver to the vacuum port 330 as indicated by arrow.

When the vacuum to the actuator is removed, the lower pressure acting at 330 will typically pull the spool to the right and sealing surface 306′ will engage with sealing surface B. In this position flow is from port 331 at atmospheric pressure to the manifold 315 and hence the receiver.

It is to be appreciated that the advantages of the above embodiments are applicable to two-position, five-port devices as well as the two-position, three-port embodiment discussed above.

1-57. (canceled)

58. A coupling for releasably joining together two fluid conduits, comprising:
first and second connectors each for attachment to a fluid conduit and each having a body defining a lumen for fluid flow therethrough in a predetermined direction;
the first and second connectors being releasably interconnectable, with the lumens in their respective bodies being registerable when interconnected so as to permit flow therebetween;
wherein at least one connector further comprises a shutter movable relative to the lumen and in a plane perpendicular to the predetermined direction from a first position in which fluid flow through the lumen is prevented to a second position in which fluid flow through the lumen is allowed.

59. Coupling according to claim 58, wherein both connectors comprise a shutter movable in a plane perpendicular to the predetermined direction.

60. Coupling according to claim 59, wherein said shutters abut when said first and second connectors are interconnected.

61. Coupling according to claim 60, wherein the shutters have respective apertures for fluid flow therethrough, at least one connector comprising a plug to block its respective aperture when the shutter is in said first position.

62. Coupling according to claim 61, wherein at least one connector further comprises an externally-actuable member for moving said plug in and out of engagement with its respective aperture.

63. Coupling according to claim 61, wherein the plug of one connector is biased into engagement with its respective aperture and is configured to move out of engagement when subject to the pressure of fluid in the lumen of the other connector.

64. Coupling according to claim 61, wherein said plug is configured to block the aperture of both connectors.

65. Coupling according to claim 58, wherein the shutter is configured to rotate about an axis substantially parallel to said predetermined direction.

66. Coupling according to claim 58, wherein the at least one connector comprises a sleeve configured to rotate relative to the body of the at least one connector and to which said shutter is immovably fixed.

67. Coupling according to claim 66, wherein the sleeve is configured to rotate about the longitudinal axis of the body.

68. Coupling according to claim 67, wherein said sleeve has a bore in which said body rotates.

69. Coupling according to claim 66, wherein the sleeve of the at least one connector has a further bore configured to receive the other connector.

70. Coupling according to claim 69, wherein the sleeve comprises an interconnector for releasably attaching the first connector to the second connector.

71. Coupling according to claim 66, wherein the shutter has an aperture for fluid flow therethrough, the at least one connector comprises a plug to block the aperture when the shutter is in the first position, and the plug has a surface configured to engage the sleeve and move in and out of engagement with the aperture with rotation of the sleeve.

72. Coupling according to claim 71, wherein both connectors comprise plugs, the plugs being configured to abut when the respective shutters are in their first positions.

73. Coupling according to claim 58, wherein the lumen of the body of the at least one connector has an aperture blockable by said shutter, said lumen tapering towards said aperture.

74. Coupling according to claim 58, wherein the lumen of the body of the at least one connector has an aperture blockable by said shutter, said aperture being offset from the longitudinal axis of the body.

75. Coupling according to claim 58, wherein the shutter is configured to be lockable relatively to the lumens either in infinite or discrete positions between the end positions where fluid is either prevented or allowed.

76. Coupling according to claim 58, wherein provision is made to allow release of connectors only when the lumen is fully closed by the shutter.

77. Coupling according to claim 58, wherein the body of each connector is cylindrical and has a longitudinal axis, with the lumen of the body having first and second apertures with the lumen tapering therebetween, the first aperture being blockable by the shutter of the at least one connector and having a smaller cross-sectional area than the second aperture, with the first aperture being wholly disposed to one side of the longitudinal axis whilst being within a footprint of the second aperture when projected along the longitudinal axis.
